(19) United States
(12) Patent Application Publication
(10) Pub. No.: US 2026/0084926 A1
(43) Pub. Date: Mar. 26, 2026

(54) EXCEPTION TOOL FOR VIRTUAL SAFETY NET SYSTEM

(71) Applicant: Otis Elevator Company, Farmington, CT (US)

(72) Inventors: James Tilsley Auxier, Palm Beach Gardens, FL (US); Kathleen Nicole Moore, West Hartford, CT (US); Randall Roberts, Hebron, CT (US); Jesse R. Richter, West Hartford, CT (US); Kyler Vensel, Wolcott, CT (US)

(21) Appl. No.: 18/896,112

(22) Filed: Sep. 25, 2024

(51) Int. Cl. B66B 5/00; B66B 3/00; B66B 5/02

(52) U.S. Cl. CPC B66B 5/005; B66B 3/002; B66B 5/02

(57) ABSTRACT

A virtual safety net system includes at least one active remote sensor configured to output energy that establishes an energy safety net and to detect reflected energy that is reflected from an object disposed in the energy safety net, and a processor in signal communication with the at least one active remote sensor. The processor is configured to determine an energy intensity of the reflected energy and to identify the object as an exception tool permitted to be disposed in the energy safety net in response to the energy intensity exceeding an energy intensity threshold.

### BACKGROUND

The present disclosure relates to conveyance systems and, in particular, to an exception tool for use in a virtual safety net system.

Conveyance systems such as elevators, escalators, etc., may have various hazard areas or zones (e.g., pinch points) that should be treated with safety, but still may require maintenance. In an elevator system, for example, an elevator shaft is built into a building and defined by the building's walls. The elevator car travels up and down along the elevator shaft to arrive at landings of different floors of the building. The movement of the elevator car is driven by a machine that is controlled by a controller according to instructions received from users of the elevator system. The top of the elevator car typically includes a top landing where mechanics may be required to perform maintenance work on the elevator system. The car top typically includes handrails that aim to protect the mechanic while performing the maintenance. To further protect mechanics, elevator systems have recently implemented various safety monitoring systems that can detect mechanics leaning over the handrails and alert them to readjust their position.

### SUMMARY

According to an aspect of the disclosure, a virtual safety net system includes at least one active remote sensor configured to output energy that establishes an energy safety net and to detect reflected energy that is reflected from an object disposed in the energy safety net, and a processor in signal communication with the at least one active remote sensor. The processor is configured to determine an energy intensity of the reflected energy and to identify the object as an exception tool permitted to be disposed in the energy safety net in response to the energy intensity exceeding an energy intensity threshold.

In accordance with additional or alternative embodiments, the processor identifies the object as an unauthorized object that is not permitted to be disposed in the energy safety net in response to the energy intensity being less than or equal to the energy intensity threshold.

In accordance with additional or alternative embodiments, the processor permits to the exception tool within the energy safety net without generating a safety action, and generates the safety action in response to identifying the unauthorized object.

In accordance with additional or alternative embodiments, the safety action including one or both of generating an alert and activating an elevator safety chain.

In accordance with additional or alternative embodiments, the exception tool includes a retroreflective material configured to reflect the reflected energy having the first energy intensity back to the at least one active remote sensor.

In accordance with additional or alternative embodiments, the at least one active remote sensor includes a Light Detection and Ranging (LiDAR) sensor.

In accordance with additional or alternative embodiments, the energy safety net is generated as a point cloud.

In accordance with additional or alternative embodiments, the reflected energy produces point cloud, and the processor determines a shape of the object based on the point cloud data.

In accordance with additional or alternative embodiments, the process identifies one or both of the exception tool and the unauthorized object based on the shape of the object.

In accordance with additional or alternative embodiments, processor learns one or more shapes of the exception tool according to a machine learning algorithm.

According to another non-limiting embodiment, a method of operating a virtual safety net system is provided. The method comprises outputting energy from at least one active remote sensor to establish an energy safety net, and detecting reflected energy that is reflected from an object disposed in the energy safety net. The method further comprises determining, via a processor, an energy intensity of the reflected energy; and identifying the object as an exception tool permitted to be disposed in the energy safety net in response to the energy intensity exceeding an energy intensity threshold.

In accordance with additional or alternative embodiments, the method further comprises identifying the object as an unauthorized object that is not permitted to be disposed in the energy safety net in response to the energy intensity being less than or equal to the energy intensity threshold.

In accordance with additional or alternative embodiments, the method further comprises: performing at least one machine learning technique such that the processor learns a profile of an object to be designated as an exception tool; determining, by the processor, that the object disposed in the energy safety net has a first profile that is substantially the same as the learned profile or has a second profile that is substantially different from the learned profile; and identifying that the object disposed in the energy safety net having the first profile as the exception tool or identifying that the object disposed in the energy safety net having the second first profile as the unauthorized object.

In accordance with additional or alternative embodiments, the method further comprises: permitting the exception tool within the energy safety net without generating a safety action; and generating the safety action in response to identifying the unauthorized object.

In accordance with additional or alternative embodiments, the safety action includes one or both of generating an alert and activating an elevator safety chain.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an elevator system according to a non-limiting embodiment;

FIG. 2 is a perspective view of an elevator safety net system installed on top of an elevator car included in the elevator system shown in FIG. 1 according to a non-limiting embodiment;

FIG. 3A is a side view of the top of the elevator car shown in FIG. 2 with an authorized exception tool disposed in an area of interest monitored by the elevator safety net system according to a non-limiting embodiment;

FIG. 3B is a side view of the top of the elevator car shown in FIG. 2 with an unauthorized object disposed in an area of interest monitored by the elevator safety net system according to a non-limiting embodiment;

FIG. 4 is a perspective view of an elevator safety net system installed on top of the elevator car included in the elevator system shown in FIG. 1 according to another non-limiting embodiment;

FIG. 5 is a side view of the top of the elevator car shown in FIG. 4 with an authorized exception tool disposed in an area of interest monitored by the elevator safety net system according to another non-limiting embodiment;

FIG. 6 is a flow diagram illustrating a method of identifying an exception tool permitted to reside in an critical area of interest according to non-limiting embodiments; and

FIG. 7 is a flow diagram illustrating a method of operating an elevator safety net system according to non-limiting embodiments.

### DETAILED DESCRIPTION

Conveyance systems such as elevators, escalators, moving walkways, etc., may include multiple monitors and sensors to monitor various parts, components and/or hazard areas. In the elevator industry, for example, multiple monitors and sensors are provided to monitor various parts and components of an elevator system. Particularly, critical areas to monitor are the elevator car top, where mechanics commonly stand to perform various maintenance work. A cost-effective way of detecting a person, such as a service technician or a mechanic, performing work on the car top is needed.

Active remote sensor safety systems, sometimes referred to as a virtual safety net system, or when employed in an elevator system an “elevator safety net system”, have recently been implemented to monitor critical area of interest (AOI) or volume of interest (VOI) of an elevator system such as, for example, the elevator pit, the elevator pit ladder, and the handrails located at the top of the elevator car. The virtual safety net system includes one or more active remote sensors disposed at the critical areas of the elevator system to be monitored. An active remote sensor such as a Light Detection and Ranging (LiDAR) sensor, for example, is configured to output an energy signal (e.g., laser light) and to measure the intensity of the reflected energy that is reflected from an object on which the energy signal impinges. However, there are times when maintenance procedures that would otherwise cause the virtual system net system to generate an alarm and disable operation must instead allow the elevator system to continue operating while maintenance procedures are safely performed as the virtual safety net system continues monitoring the critical AOI.

Various non-limiting embodiments of the present disclosure provide an exception tool that is compatible with a virtual safety net system. The exception tool is a unique tool that is distinguished from other objects and is permitted or authorized to be disposed or located within a critical AOI without causing the virtual safety net system to generate an emergency alert and/or disable the elevator system. Accordingly, the virtual safety net system can perform its intended safety monitoring and alert functionality while seamlessly permitting certain approved exception tools to access safety critical areas of interest. In this manner, maintenance technicians can access safety critical areas of interest to perform maintenance work without comprising the safety monitoring performed by the virtual safety net system.

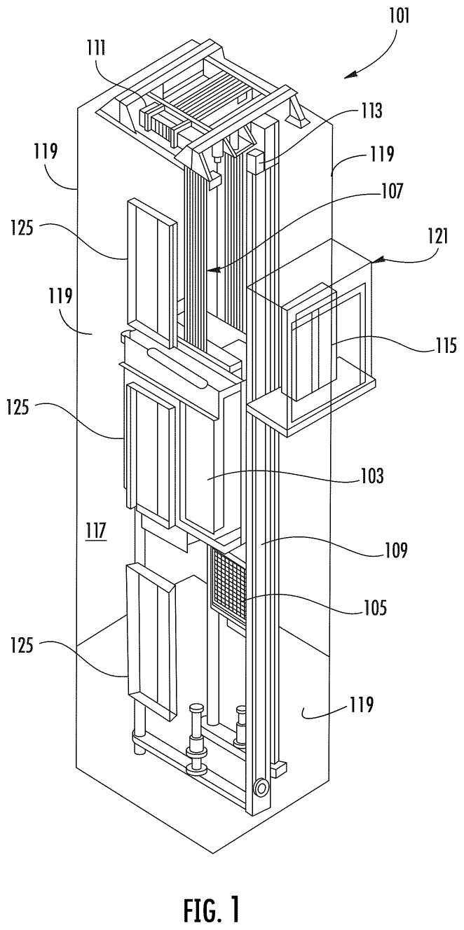

With reference to FIG. 1, which is a perspective view of an elevator system 101, the elevator system 101 includes an elevator car 103, a counterweight 105, a tension member 107, a guide rail 109, a machine 111, a position reference system 113 and a controller 115. The elevator car 103 is disposed in an elevator shaft 117 defined by surrounding shaft walls 119. The elevator car 103 and the counterweight 105 are connected to each other by the tension member 107. The tension member 107 may include or be configured as, for example, ropes, steel cables and/or coated-steel belts. The counterweight 105 is configured to balance a load of the elevator car 103 and is configured to facilitate movement of the elevator car 103 concurrently and in an opposite direction with respect to the counterweight 105 within the elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the elevator shaft 117 and is configured to control the operation of the elevator system 101, and particularly the elevator car 103. It is to be appreciated that the controller 115 need not be in the controller room 121 but may be in the elevator shaft 117 or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

The elevator system 101 also includes one or more elevator doors 104. The elevator door 104 may be integrally attached to the elevator car 103 or the elevator door 104 may be located on a landing 125 of the elevator system 101, or both. Embodiments disclosed herein may be applicable to both an elevator door 104 integrally attached to the elevator car 103 or an elevator door 104 located on a landing 125 of the elevator system 101, or both. The elevator door 104 opens to allow passengers to enter and exit the elevator car 103. The elevator system 101 further includes a “safety chain”. Accordingly, activating the elevator safety chain can cuts power to the elevator motor and elevator brakes to bring the elevator car 103 to a safe stop in the event of some detected failure or safety-related condition.

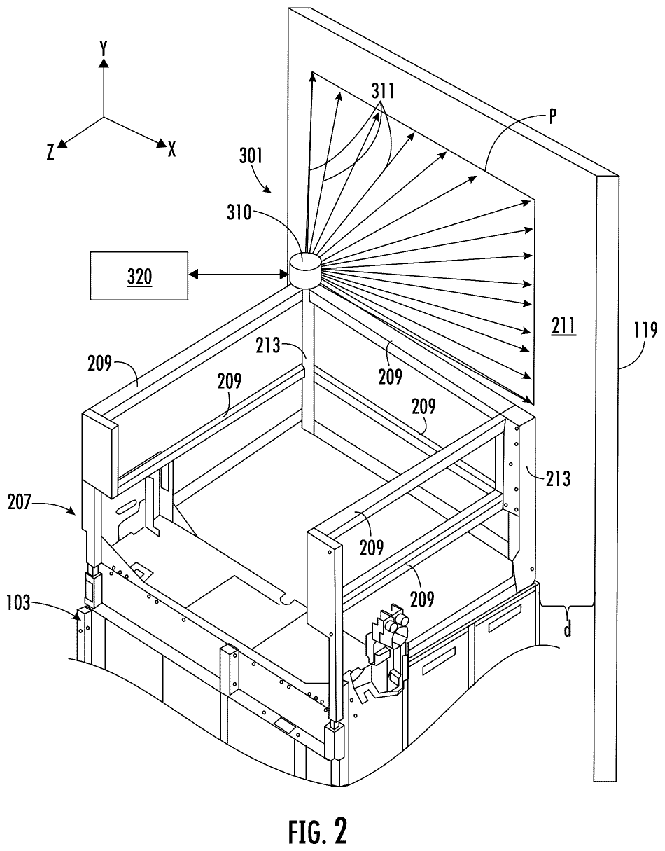

With continued reference to FIG. 1 and with additional reference to FIG. 2, a top 207 of the elevator car 103 (i.e., a car top 207) included in the elevator system 101 is illustrated. The elevator car 103 is disposed in front of a shaft wall 119 by a distance (d). The car top 207 includes a top landing 208 and one or more handrails 209 that surround, or partially surround, the top landing 208.

With continued reference to FIG. 2, a virtual safety net system 301 (e.g., an elevator safety net system 301) is installed on the car top 207. The elevator safety net system 301 includes a sensor 310 and a processor 320. The elevator safety net system 301 is provided to reliably identify whether an unauthorized object is located in an AOI 211. In this example, the AOI 211 is an area that extends beyond the handrails 209 (e.g., between a handrail 209 and a shaft wall 119). When an unauthorized object is detected within the AOI 211, the elevator safety net system 301 can perform a safety action such as, for example, generating an alert (e.g., sound alert, light alert, etc.) and/or disabling the elevator system 101. It should be appreciated that the designated AOI 211 between the handrail 209 and the shaft wall 119 is just one example, and other AOIs 211 can be monitored by the elevator safety net system 301 without departing from the scope of the invention.

In the example shown in FIG. 2, the sensor 310 is implemented as an active remote sensor 310 (e.g., a LiDAR sensor) and is arranged in a plane (P). According to a non-limiting embodiment, the sensor 310 can be adjusted so that the plane (P) extends between opposing corners 213 of the handrail 209, and between the handrail(s) 209 and one or more of the shaft walls 119 so that the plane (P) is located in the AOI 211. The sensor 310 is configured to perform sensing to sense an object that crosses the plane (P), and to generate data corresponding to results of the sensing. Although a single sensor 310 is shown, it should be appreciated that additional sensors 310 can be implemented without departing from the scope of the present disclosure.

The processor 320 includes a processing unit, a memory, an input/output (I/O) unit by which the processor 320 is communicative with the sensor 310, and at least a main controller (e.g., controller 115). The memory has executable instructions and software stored thereon, which are readable and executable by the processing unit. When the processor 320 reads and executes the executable instructions and/or software, the processor 320 is commanded to operate as described herein. In accordance with embodiments, the executable instructions and/or software may include a machine-learning algorithm, which improves certain operations of the processing unit over time. For example, the machine-learning algorithm can learn the shape and profile of objects categorized as an exception tool (e.g., off-line), which is permitted to be disposed in the AOI 211 versus an unauthorized object that is not permitted to be disposed in the AOI 211. In a non-limiting embodiment, candidate exception tools, wearables, or other objects can be tested and characterized by the elevator safety net system 301 in a calibration step. For example, Machine Learning techniques can be applied to create and incorporate a deployable classification algorithm into the elevator safety net system 301. These objects can then be registered and incorporated into the elevator safety net system 301, which updates the running classification algorithm with revised software downloads.

The processor 320 can be remote from the sensor 310 or local to the sensor 310. In the former case, the processor 320 can be operably coupled to the sensor 310 via a wired connection or via a wireless connection. In the latter case, the processor 320 can be built into the sensor 310 (e.g., integrated) or provided as a separate component from the sensor 310 and operably coupled to the sensor 310 via a wired connection or via a wireless connection. In one or more non-limiting embodiments, processor 320 can also read car motion status from a switch or a controller (e.g., controller 115) to determine if the elevator car 103 is moving. If so, the elevator system 101 can perform a “disable” reaction when a person is detected, an/or an alert can be generated.

In accordance with embodiments, the sensor 310 can include or be provided as one or more of a light detection and ranging or a laser imaging, detection, and ranging (LiDAR) sensor, a radio detection and ranging (RADAR) sensor, infrared (IR) sensors, and/or a camera. In accordance with further embodiments, the sensor 310 can be provided as one or more of a two-dimensional (2D) LiDAR sensor, a three-dimensional (3D) LiDAR sensor, a millimeter wave RADAR sensor and/or a red, green, blue, depth (RGBD) camera. In accordance with still further embodiments, the sensor 310 can be provided as plural sensors including a combination of one or more sensor types listed herein.

The sensor 310 (e.g., a 2D LiDAR) emits energy 311 (e.g., IR energy or laser pulses) along plane (P) and into the AOI 211 to establish an energy safety net. It should be appreciated that although a 2D plane (P) is described in FIG. 2, the sensor 310 can emit IR energy 311 that defines a 3D space when implementing the sensor 310 as, for example, a 3D LiDAR sensor. According to a non-limiting embodiment, the AOI or volume of interest (VOI) can be set during the installation step based on the particular dimensions of the critical area or hazard area to be monitored. (either on top-of-car, pit ladder or pit area). This allows proper orientation and projection of the energy safety net according to a specific arrangement and geometry. Once set, the projected IR energy 311 can generate point cloud data using a single scan for image processing, multiple scans for image processing and/or multiple successive or continuous scans for video processing.

As described herein, the processor 320 can generate an alert when an unauthorized object crosses the plane (P) and is located in the AOI 211, while disregarding an exception tool when it crosses the plane (P) and is located in the AOI 211. In this manner, mechanics can access safety critical areas of interest to perform maintenance work without needing to disabling the elevator safety net system 301.

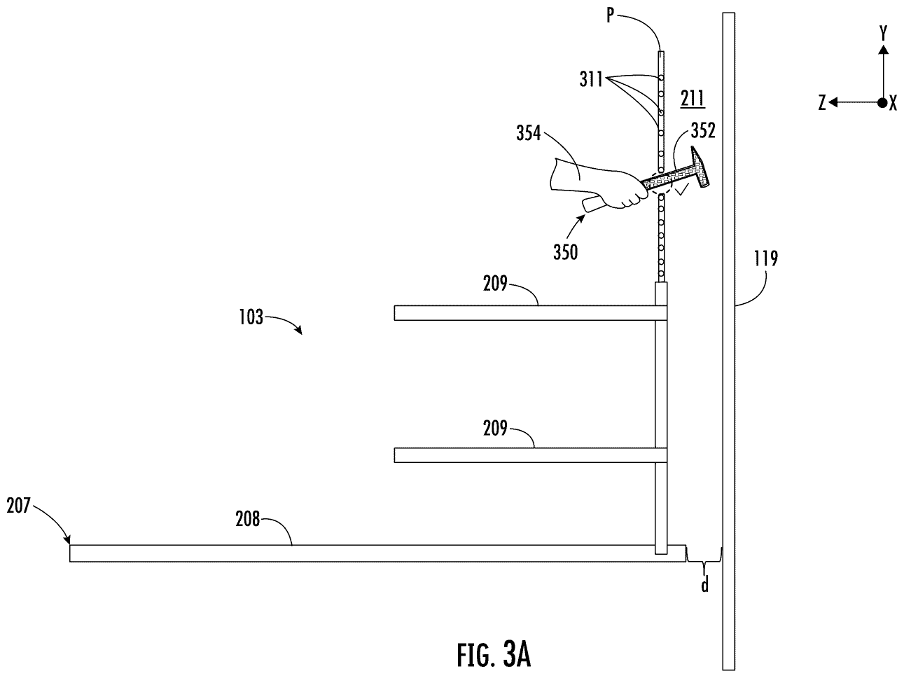

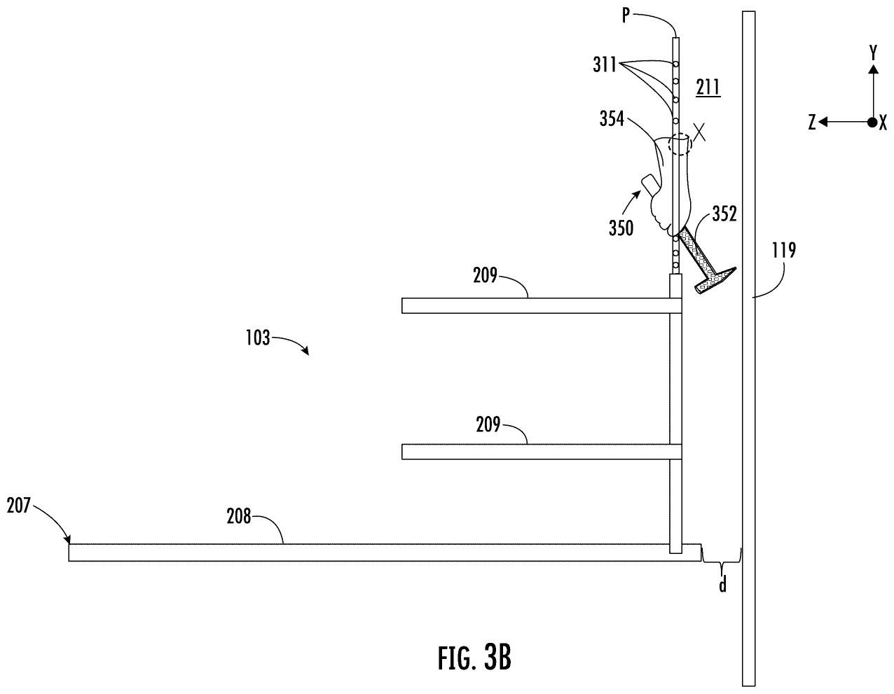

Turning to FIGS. 3A and 3B, operation of the elevator safety net system 301 in conjunction with an exception tool 350 is illustrated according to a non-limiting embodiment. In this example, the exception tool 350 is illustrated as a hammer. It should be appreciated, however, that the exception tool can be implemented using other tools without departing from the scope of the invention. In some embodiments, the exception tool 350 can be a custom tool that is custom fabricated (e.g., using 3D additive manufacturing) to have a unique shape and profile that can be learned by the elevator safety net system 301 (e.g., processor 320) using one or more machine learning techniques as described herein.

The exception tool 350 is formed from, or includes a portion, comprising a retroreflective material 352, which directs incoming IR pulses 311 output from the sensor 310 back along the same path from which they originated, i.e., back toward the sensor 310. The retroreflective material 352 can be integrated or unitary with the exception tool 350, or can be a separate component that is coupled or applied (e.g., a retroreflective adhesive tape, a retroreflective wrap, a retroreflective paint, a retroreflective covering, etc.). The retroreflective material 352 includes glass or plastic reflective beads embedded in a reflective material, which reflect energy (e.g., IR energy) having an intensity that is greater than the energy reflected by objects excluding the retroreflective material 352. Thus, objects that include the retroreflective material can be categorized as an exception tool 350, while objects that exclude the retroreflective material can be categorized as unauthorized objects 354.

As described herein, the IR pulses 311 returned by the retroreflective material 352 of the exception tool 350 have a greater energy level or intensity than energy reflected by unauthorized objects 354 that exclude the retroreflective material 352. As shown in FIG. 3A, for example, a portion of the exception tool 350 including the retroreflective material 352 crosses the plane (P) and into the AOI 211, thereby reflecting a portion of the IR energy 311 back to the sensor 310. The processor 320 (e.g., software) determines that the intensity of the reflected energy is greater than an intensity threshold and determines that exception tool 350 is permitted to be located in the AOI 211. In this manner, maintenance technicians can utilize the exception tool 350 to access the AOI 211 and perform maintenance work without need to disabling the elevator safety net system 301.

In FIG. 3B, however, a portion of a mechanic (e.g., the mechanic's hand) that excludes the retroreflective material 352 crosses the plane (P) and reflects IR energy back to the sensor 310. The processor 320 (e.g., software) determines that the intensity of the reflected energy is less than or equal to the intensity threshold and determines that an unauthorized object is located in the AOI 211. Accordingly, the processor 320 can initiate a safety action such as, for example, an audio alert, a visual alert and/or disablement of the elevator system 101.

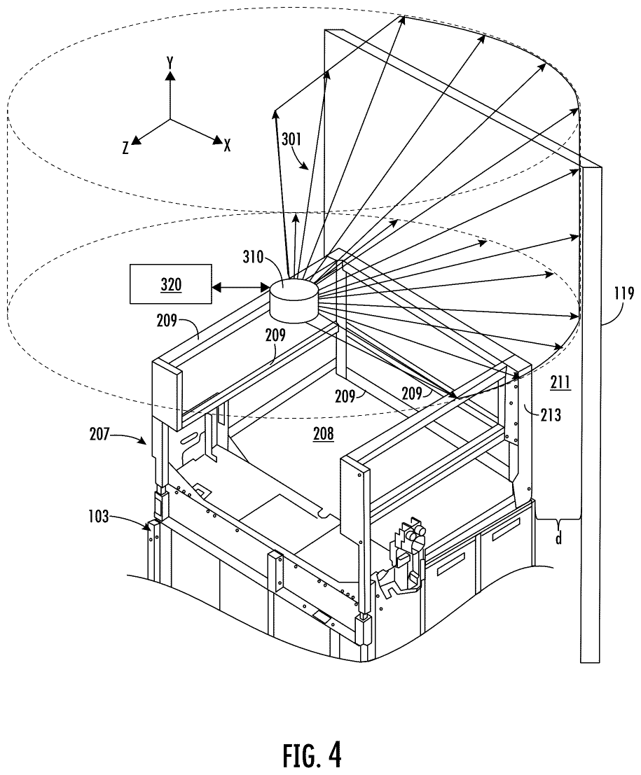

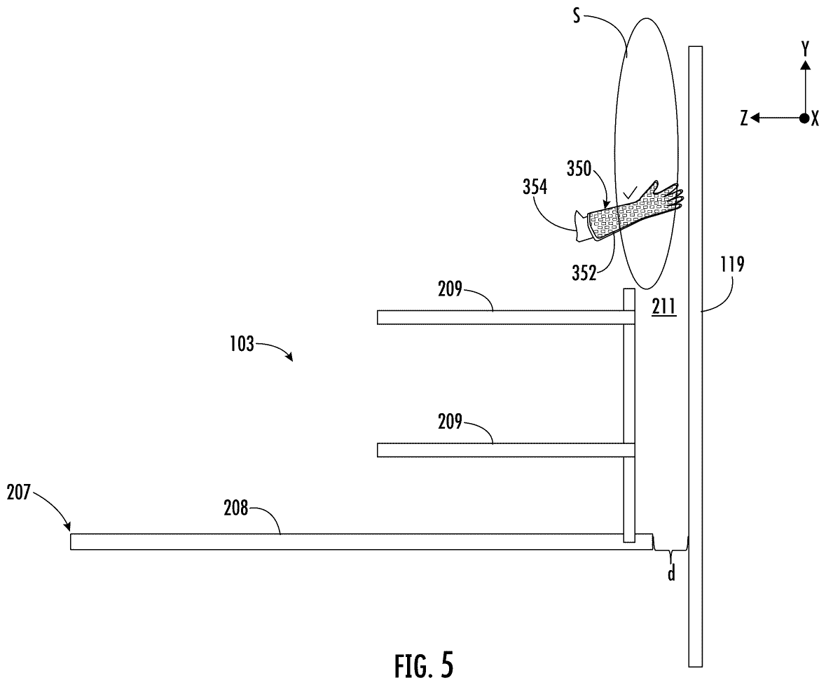

Turning now to FIGS. 4 and 5, operation of the elevator safety net system 301 in conjunction with an exception tool 350 is illustrated according to another non-limiting embodiment. In this example, an exception tool 350 is utilized in an elevator safety net system 301 that implements the sensor 310 as a 3D LiDAR. The sensor 310 produces IR energy 311 defining a 3D space that covers the AOI 211 located between the handrail 209 and the shaft wall 119. The exception tool 350 in this example is a glove 350 including retroreflective material 352, which can be worn by a mechanic when performing maintenance work. Accordingly, the elevator safety net system 301 permits the exception tool 350 (e.g., the glove) to access the AOI 211 without initiating the safety procedure, i.e., generating an alert and disabling the elevator system.

Although the examples above employ the elevator safety net system 301 on the top 207 of an elevator car 103 to monitor an AOI 211 between a handrail 209 and a shaft wall 119, it should appreciated that the exception tool 350 can utilized with elevator safety net systems 301 that are located on other areas of the elevator car 103 and/or that monitor other AOIs 211 of the elevator system. For example, the elevator safety net system 301 can be employed in the elevator pit 201 to monitor the pit floor and/or the pit ladder without departing from the scope of the invention. Additional sensing in these or other cases can also alternate sensing (mmWave or RGB-D cameras), two or more sensors, coverage of different plans with 2D sensors and ranges of data/image processing approaches, including but not limited to image classification, machine learning, pattern recognition, etc.

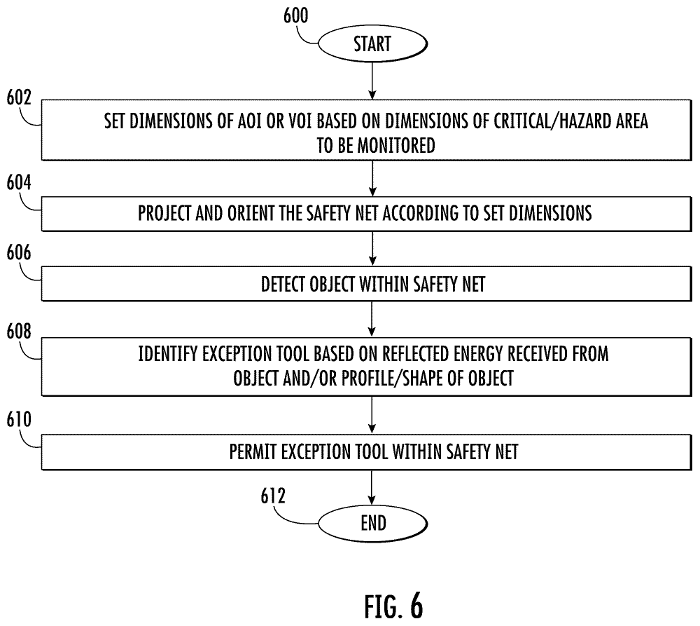

Referring to FIG. 6, a method of identifying an exception tool permitted to reside in an critical area of interest is illustrated according to non-limiting embodiments. The method begins at operation 600, and at operation 602 an AOI or VOI is set during installation of the elevator safety net system based on the particular dimensions of the critical area or hazard area to be monitored (e.g., top-of-car, pit ladder, pit area, etc.). At operation 604, IR energy establishing the safety net is projected and orientated according to the set dimensions of the AOI or VOI. Although IR energy is described in this example, it should be appreciated that additional sensing techniques can be employed such as, for example, mmWave sensing or RGB-D cameras. At operation 606, an object disposed in the projected safety net is detected, and at operation 608 the object is identified as an exception tool based on the energy reflected from the object and/or the profile or shape of the object. According to a non-limiting embodiment, the profile or shape of various exception tools can be learned and characterized off-line (e.g., using Machine Learning). At operation 610, the identified exception tool is permitted within the safety net without generating an alert, and the method ends at operation 612.

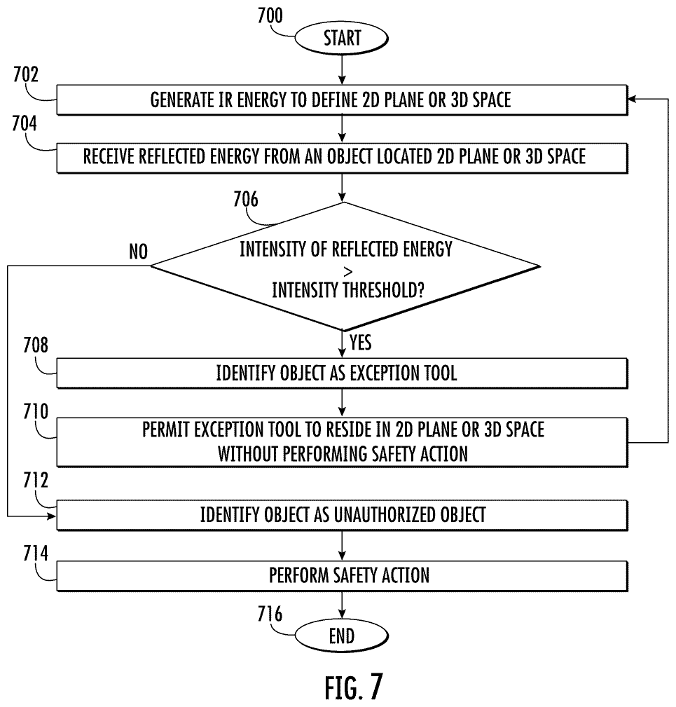

Referring now to FIG. 7, a method of operating an elevator safety net system is illustrated according to a non-limiting embodiment of the present disclosure. The method begins at operation 700, and IR energy is output from a sensor (e.g., a LiDAR sensor) included in the elevator safety net system at operation 702. The IR energy defines a two-dimensional (2D) plane or a three-dimensional (3D) space, which are located or cover an AOI to be monitored by the elevator safety net system. According to a non-limiting embodiment, the AOI or VOI can be set during installation of the elevator safety net system based on the particular dimensions of the critical area or hazard area to be monitored (e.g., top-of-car, pit ladder, pit area, etc.). This allows proper projection and orientation of the safety net according to a specific arrangement and geometry. At operation 704, energy reflected from an object located in the 2D plane or the 3D space is detected by the sensor. At operation 706, an intensity of the reflected energy is compared (e.g., by a processor) to an intensity threshold. When the energy intensity is above the intensity threshold, the elevator safety net system (e.g., processor 320) identifies the object as an exception tool at operation 708, and permits the exception tool to reside in the 2D plane or the 3D space without performing a safety action at operation 710. Accordingly, the method returns to operation 702 and continues outputting the IR energy from the sensor.

When, however, the intensity of the energy reflected by the object is equal to or below the intensity threshold at operation 706, the object is identified (e.g., by the processor) as an unauthorized object at operation 712. At operation 714, a safety action is performed. The safety action can include, for example, an audio alert, a visual alert and/or disablement of the elevator system, and the method ends at operation 716. Accordingly, the elevator safety net system can perform its intended safety monitoring and alert functionality while seamlessly permitting certain approved exception tools to access safety critical areas of interest. In this manner, mechanics can access safety critical areas of interest to perform maintenance work without comprising the safety monitoring performed by the elevator safety net system.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A virtual safety net system comprising:
at least one active remote sensor configured to output energy that establishes an energy safety net and to detect reflected energy that is reflected from an object disposed in the energy safety net; and
a processor in signal communication with the at least one active remote sensor, the processor configured to determine an energy intensity of the reflected energy,
wherein the processor identifies the object as an exception tool permitted to be disposed in the energy safety net in response to the energy intensity exceeding an energy intensity threshold.

2. The virtual safety net system of claim 1, wherein the processor identifies the object as an unauthorized object that is not permitted to be disposed in the energy safety net in response to the energy intensity being less than or equal to the energy intensity threshold.

3. The virtual safety net system of claim 2, wherein the processor permits to the exception tool within the energy safety net without generating a safety action, and generates the safety action in response to identifying the unauthorized object.

4. The virtual safety net system of claim 3, wherein the safety action including one or both of generating an alert and activating an elevator safety chain.

5. The virtual safety net system of claim 1, wherein exception tool includes a retroreflective material configured to reflect the reflected energy having the first energy intensity back to the at least one active remote sensor.

6. The virtual safety net system of claim 5, wherein the at least one active remote sensor includes a Light Detection and Ranging (LiDAR) sensor.

7. The virtual safety net system of claim 1, wherein the energy safety net is generated as a point cloud.

8. The virtual safety net system of claim 7, wherein the reflected energy produces point cloud, and the processor determines a shape of the object based on the point cloud data.

9. The virtual safety net system of claim 8, wherein the processor identifies one or both of the exception tool and the unauthorized object based on the shape of the object.

10. The virtual safety net system of claim 9, wherein the processor learns one or more shapes of the exception tool according to a machine learning algorithm.

11. An exception tool configured to use in a virtual safety net system, the exception tool comprising:
an object including a retroreflective material disposed on at least a portion of the object,
wherein the retroreflective material is configured to reflect energy having a first energy that is greater than an energy threshold to identify the object as the exception tool.

12. The exception tool of claim 11, wherein the retroreflective material includes reflective beads embedded therein.

13. The exception tool of claim 12, wherein the retroreflective material includes one or both of a retroreflective adhesive tape, a retroreflective wrap, a retroreflective paint and a retroreflective covering.

14. The exception tool of claim 12, wherein the retroreflective material is unitary with the object.

15. The exception tool of claim 12, wherein the object has a custom shape configured to be learned by the virtual safety net system as the exception tool.

16. A method of operating a virtual safety net system, the method comprising:
outputting energy from at least one active remote sensor to establish an energy safety net;
detecting reflected energy that is reflected from an object disposed in the energy safety net;
determining, via a processor, an energy intensity of the reflected energy; and
identifying the object as an exception tool permitted to be disposed in the energy safety net in response to the energy intensity exceeding an energy intensity threshold.

17. The method of claim 16, further comprising identifying the object as an unauthorized object that is not permitted to be disposed in the energy safety net in response to the energy intensity being less than or equal to the energy intensity threshold.

18. The method of claim 17, further comprising:
performing at least one machine learning technique such that the processor learns a profile of an object to be designated as an exception tool;
determining, by the processor, that the object disposed in the energy safety net has a first profile that is substantially the same as the learned profile or has a second profile that is substantially different from the learned profile; and
identifying that the object disposed in the energy safety net having the first profile as the exception tool or identifying that the object disposed in the energy safety net having the second first profile as the unauthorized object.

19. The method of claim 18, further comprising:
permitting the exception tool within the energy safety net without generating a safety action; and
generating the safety action in response to identifying the unauthorized object.

20. The method of claim 19, wherein the safety action including one or both of generating an alert and activating an elevator safety chain.
